(19) United States
(12) Patent Application Publication
(10) Pub. No.: US 2006/0190169 A1
(43) Pub. Date: Aug. 24, 2006

(54) Sound information output system

(75) Inventor: Takao Kawai, Anjo-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/358,710

(22) Filed: Feb. 22, 2006

(30) Foreign Application Priority Data
Feb. 22, 2005 (JP) 2005-045999

(51) Int. Cl. G01C 21/32

(52) U.S. Cl. 701/211

(57) ABSTRACT

In a sound information output system installed in a vehicle, a first determining unit is communicable with a handsfree cellular phone unit. The handsfree cellular phone unit allows handsfree conversation. The first determining unit is configured to determine whether the handsfree cellular phone unit is in off-hook state or in on-hook state. A holding unit is configured to hold output of the first sound information when it is determined that the handsfree cellular phone unit is in off-hook state.

### CROSS REFERENCE TO RELATED APPLICATION

This application is based on Japanese Patent Application 2005-045999 filed on Feb. 22, 2005. The descriptions of this Patent Application are all incorporated herein by reference.

### BACKGROUND OF THE INVENTION

1. Field of the Invention

The present invention relates to sound information output systems installed in a vehicle and having a function of giving an occupant sound information, such as voice guidance representing a set route to a destination.

2. Description of the Related Art

As an example of sound information output systems, a vehicle navigation system has been widely installed in vehicles.

The vehicle navigation system receives signals from position measuring systems, such as global positioning satellites (GPS), calculates the current vehicle's exact location with the vehicle running, and displays the current vehicle's exact location on the screen of a display device together with an electronic map associated with the vehicle's exact location.

The vehicle navigation system also calculates the best route to occupant's destination from the current location according to occupant's instructions, and gives an occupant(s) voice or visual guidance to the destination along the calculated best route using the display device and/or a speaker.

The functions of the vehicle navigation system set forth above can contribute driver's effective and safe driving.

Specifically, such conventional vehicle navigation systems search the best route from the start place to occupant's destination, and give an occupant(s) voice or visual guidance to the destination along the best route when the vehicle approaches an intersection as an example of reminder points.

For example, every time the vehicle reaches 700 m before an intersection, 300 m before the intersection, and a point directly before the intersection on the route, the navigation system gives the driver a voice guidance. The voice guidance lets the driver know what turns are required to stay on the driver's selected route at the intersection and a landmark to find the intersection.

More specifically, when the vehicle reaches 700 m before the intersection, the voice guidance of “turn right 700 m from here” is given to the driver, and when the vehicle reaches 300 m before the intersection, the voice guidance of “turn right 300 m from here” is given to the driver. Moreover, when the vehicle runs directly before the intersection, the voice guidance of “turn right before long, and there is a landmark of “XX”” is given to the driver. This assists the driver to most certainly turn right.

By the way, the number of traffic accidents due to using a cellular telephone had increased with the growing rate of cellular telephones. The current Road Traffic Law in Japan bans the use of transceiver (cellular telephone, automobile telephone, or other types of transceivers but only provided the transceiver can transmit and receive messages only by holding the whole or part of it) while driving for telephone conversation, except in cases where the driver has no choice but to use the transceiver while driving in order to give aid to injured and sick people and/or maintain public's safety. For this reason, handsfree devices, which enable the driver to talk on the transceiver without holding it while driving, have been used.

In some of conventional navigation systems set forth above, the driver's selected route is composed of a plurality of sections, and some of the sections each containing a reminder point, such as an intersection, to give voice guidance associated with the reminder point, have been previously set. Specifically, in some of the conventional navigation systems, voice guidance associated with a reminder point in a section of the driver's selected route is given to occupants in the vehicle while the vehicle is running in the section regardless of whether the occupants talk with themselves. The voice guidance therefore may break off the occupant's conversation. Especially, if the voice guidance is not much important for the occupants, it may make the occupants uncomfortable.

In order to solve the problems set forth above, a route navigation system for navigation of a vehicle along a set route is disclosed in Japanese Unexamined Patent Publication No. H6-103497.

In the disclosed route navigation system, the timing at which voice guidance associated with a reminder point in a section of the driver's selected route is given to occupants in the vehicle while the vehicle is running in the section is set based on the sound level of the conversation between the occupants.

In addition, for avoiding overlaps of voice guidance messages, a voice guidance system, which is disclosed in Japanese Unexamined Patent Publication No. 2002-236029, controls the sequencing of the voice guidance messages based on importance of the voice guidance messages. Specifically, the voice guidance system is operative to cancel the output of a current voice guidance message and to output the next voice guidance message when the importance of the next voice guidance message is greater than the current voice guidance message.

In the Unexamined Patent Publication No. H6-103497, the route navigation system monitors the sound level of the conversation between the occupants, and gives voice guidance to the occupants at the timing when the conversation is determined to be interrupted based on the monitored result.

During handsfree conversation, the route navigation system disclosed in the Patent Publication No. H6-103497 however may erroneously determine that the conversation is interrupted when the driver is listening to the other end of the handsfree conversation, resulting that voice guidance is given to the occupants. This may interfere with the driver's handsfree conversation. In addition, the route navigation system determines that the driver's speech is the most important. This may cause a voice guidance message, which is low in the order of importance, not to be output when the output timing of the voice guidance message is overlapped on the driver's speech.

When determining that the handsfree conversation is interrupted by distinguishing between the completion of handsfree conversation based on only the driver's voice and the timing at which a conversation between the occupants, that is, the driver and a passenger(s), the route navigation system requires the following recognition and analysis process Specifically, as the recognition and analysis process, the navigation system performs not only recognition of speakers and/or presence or absence of the conversations (vocal productions), but also analysis of the details of the conversations. This requirement of analysis of the conversations may increase the program development cost for the analysis.

In addition, in the Unexamined Patent Publication No. 2002-236029, it is true that overlaps of the output timings of the voice guidance messages are avoided, but it may be difficult to avoid overlaps between handsfree conversation and the voice guidance messages. Moreover, it will be hard to output a voice guidance message, which is overlapped on a current handsfree conversation, after the completion of the current handsfree conversation.

### SUMMARY OF THE INVENTION

The present invention has been made on the background above. Specifically, an object of at least one preferable embodiment of the present invention provides a sound information output system capable of preventing handsfree conversation from being interrupted by output sound information.

According to one aspect of the present invention, there is provided a sound information output system installed in a vehicle and configured to output first sound information. The system includes a first determining unit communicable with a handsfree cellular phone unit that allows handsfree conversation and configured to determine whether the handsfree cellular phone unit is in off-hook state or in on-hook state. The system also includes a holding unit configured to hold output of the first sound information when it is determined that the handsfree cellular phone unit is in off-hook state.

### BRIEF DESCRIPTION OF THE DRAWINGS

Other objects and aspects of the invention will become apparent from the following description of embodiments with reference to the accompanying drawings in which:

FIG. 1 is a block diagram schematically illustrating an example of the functional structure of a vehicle navigation system according to an embodiment of the invention;

FIG. 2 is a flowchart schematically illustrating operations of a control circuit illustrated in FIG. 1 according to the embodiment;

FIG. 3 is a flowchart schematically illustrating operations of the control circuit illustrated in FIG. 1 according to the embodiment;

FIG. 4 is a flowchart schematically illustrating part of the operations of the control circuit illustrated in FIG. 1 according to the embodiment;

FIG. 5 is a flowchart schematically illustrating operations of the control circuit illustrated in FIG. 1 according to a first modification of the embodiment; and

FIG. 6 is a flowchart schematically illustrating operations of the control circuit illustrated in FIG. 1 according to a second modification of the embodiment.

### DETAILED DESCRIPTION OF AN EMBODIMENT OF THE INVENTION

An embodiment of the present invention will be described hereinafter with reference to the accompanying drawings.

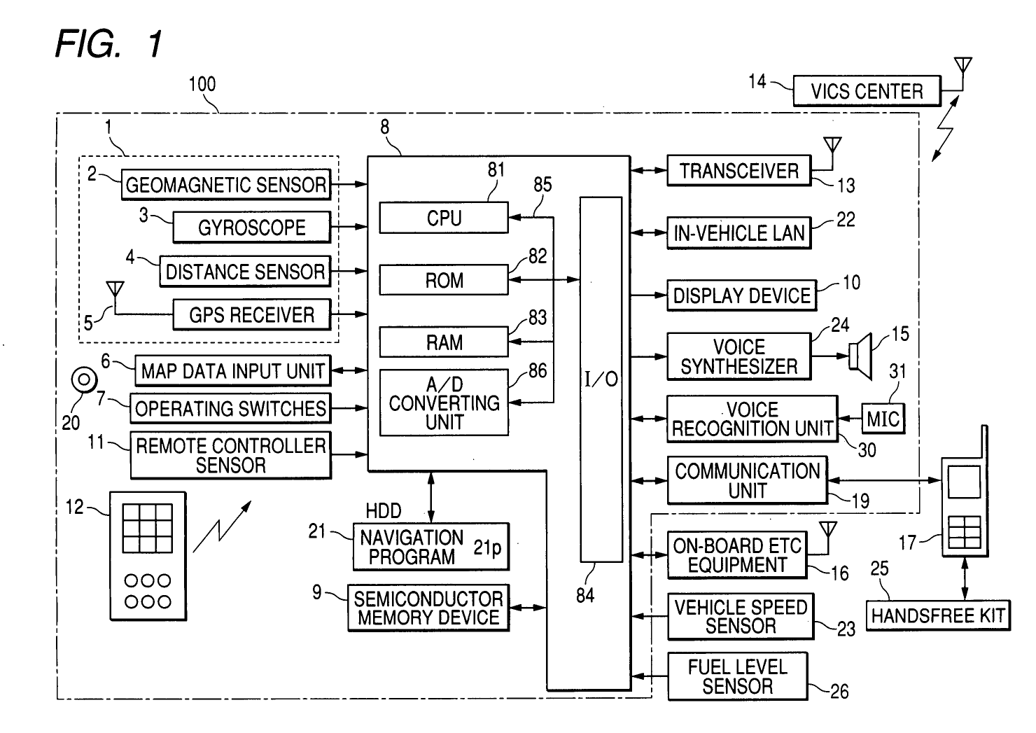

FIG. 1 illustrates an example of the functional structure of a vehicle navigation system 100 as an example of sound information output systems, installed in a vehicle; this vehicle navigation system 100 is referred to as “navigation system 100” hereinafter. As illustrated in FIG. 1, the navigation system 100 includes a position detecting unit 1, a map data input unit 6, operating switches 7, and a remote controller sensor 11. The navigation system 100 also includes a voice (speech) synthesizer 24, a speaker 15, a semiconductor memory device 9, a display device 10, a hard disc drive (HDD) 21, and a control circuit 8 communicably connected to the elements 1, 6, 7, 11, 24, 9, 10, and 21. The navigation system 100 further includes a remote controller 12.

The position detecting unit 1 is provided with a geomagnetic sensor 2 for sensing the absolute orientation of the vehicle based on geomagnetism, and a gyroscope 3 for sensing the magnitude of turning movements applied to the vehicle. The position detecting unit 1 is also provided with a distance sensor 4 for measuring the travel distance of the vehicle based on a signal indicative of a vehicle speed sent from the control circuit 8, and a GPS receiver 5. The GPS receiver 5 is configured to receive signals from GPS (Global Positioning Satellites). Operations of the elements 2 to 5 are commonly known in persons skilled in the art. The sensed, measured, and/or received items of analog data are input to the control circuit 8.

Items of digital data corresponding to the items of analog data allow the control circuit 8 to compensate for sensor management errors of the elements 2 to 5 between each other, and to calculate the vehicle's geographical current exact location (position). At least part of the elements 2 to 5 can constitute the position detecting unit 1 depending on accuracy required for detecting the vehicle's position, and the position detecting unit 1 can use a steering sensor, wheel speed sensors, and the like for detecting the vehicle's location.

The map data input unit 6 is electrically connected to a storage medium 20, such as CD-ROM, DVD-ROM, Memory Card, or other similar media. The storage medium 20 has stored therein map data including map matching data for improving the vehicle's position detection and rode data indicative of junctions of roads. The map matching data allows the control circuit 8 to correct inaccuracies between the electrical map and the detected vehicle's position by the position detecting unit 1 so as to match the detected vehicle's position to the nearest load on the map.

The map data includes predetermined map image information for display, link information, node information, and inter-link connection information. The link information represents predetermined sections of each link corresponding to each road. Specifically, the link information includes the position coordinate, the distance, the time distance, the width, the number of traffic lanes, the limiting speed, and the like of each section of each road (link). The node information includes information deciding junctions including intersections, forks, and the like as nodes. Specifically, the node information includes the position coordinate, the number of right and left turn lanes, links of destinations, and the like of each node (each junction). The inter-link information includes data representing that each connection of the links is travelable or untravelable.

The operating switches 7 for example include a touch sensitive device integrated with the display device 10. Specifically, the touch sensitive device is composed of a plurality of infrared sensors minutely arranged on the screen of the display device 10 in rows and columns, and a panel unit configured to convert information detected by at least one of the infrared sensors into an electric signal. In addition, the touch sensitive device includes a signal processing circuit configured to transmit the electric signal to an external device, and a controller configured to control the infrared sensors, the panel unit, and the signal processing circuit.

For example, when a point on the screen is touched by a finger or a stylus pen, infrared radiation at the touched point is interrupted so that the touched point is detected as the two-dimensional coordinates (X, Y).

As another type of the touch sensitive device, a resistant-film touch sensitive device can be used. The resistant-film touch sensitive device is composed of a glass substrate, a bright resistant film (conducting layer) mounted on the glass substrate, and an electrode grid composed of first electrode bars in the direction of the x-axis and second electrode bars in the direction of the y-axis that cross each other. The resistant film and the electrode grid are spaced from each other by a spacer. When a point on the resistant film is touched by, for example, a finger, the touched point contacts to the corresponding portion of the electrode grid to be short-circuited. This causes the voltage at the touched point to be changed, so that the touched point is detected as the two-dimensional coordinates (X, Y).

As a further type of the touch sensitive device, a capacitance type touch sensitive device can be used. The capacitance type touch sensitive device is composed of a bright glass substrate with one and the other opposing surfaces, and conductive layers mounted on the one and the other surfaces of the bright glass substrates, respectively. When a point on one of the bright glass substrates is touched by, for example, a finger, the capacitance change at the touched point is detected as an electric signal representing the two-dimensional coordinates (X, Y) of the touched point.

The operating switches 7 can include mechanical switches, or a pointing device, such as a mouse and a mouse pointer (mouse cursor). The operating switches 7 can include a voice recognition unit 30 and a microphone 31. The microphone 31 and the voice recognition unit 31 allow a user (an occupant) to input various operation commands by voice to the control circuit 8. Specifically, the voice corresponding to the operation commands is input to the microphone 31 so that it is converted into an electrical sound signal. The sound signal is subjected to voice recognition, so that it is converted into the corresponding operation commands.

More particularly, the voice recognition unit 30 includes an amplifier for amplifying the level of the sound signal input from the microphone 31 to a predetermined level thereof, and a memory storing therein reference data used for voice recognition. The voice recognition unit 30 includes a digital signal processor (DSP) for converting the amplified sound signal into digital sound data and for comparing the sound data with the reference data using a voice recognition algorism, such as Hidden Markov Model, thereby recognizing the sound data. The recognized result of the sound data in the form of, for example, numerical data, is sent to the control circuit 8. The voice recognition functions of the voice recognition unit 30 can be installed in the control circuit 8 as its functions based on voice recognition programs.

In addition, the remote controller 12 is configured to send various operation commands to the control circuit 8.

Specifically, in the embodiment, the operating switches 7, the set of the microphone 31 and the voice recognition unit 31, and the remote controller 12 allow various operation commands to be input to the control circuit 8.

Moreover, the navigation system 100 includes a transceiver 13 electrically connected to the control circuit 8 and to a VICS (Vehicle Information and Communication System) center 14. The VICS center 14 provides, to the control circuit 8 through the transceiver 13, latest traffic information such as traffic congestion, restriction, guides on road, and parking lots.

The navigation system 100 includes a communication unit 19. For example, connection of a cellular phone 17 and/or a mobile communication device, such as an automobile telephone, to the communication unit 19 allows the control circuit 8 to communicate with external devices and/or external networks, such as the Internet therethrough.

The navigation system 100 can include an on-board ETC (Electric Toll Collection) equipment 16 communicable with ETC roadside radio devices. The on-board ETC equipment 16 and the ETC roadside radio devices allow automatic toll payment on toll roads. In this structure, the control circuit 8 can communicate with the on-board ETC equipment 16 to load toll payment information from the on-board ECT equipment 16; this toll payment information is received from the ETC roadside radio devices. The on-board ETC equipment 16 allows the control circuit 8 to communicate with external networks. The set of the cellular phone 17 and the communication unit 19 and/or the on-board ETC equipment 16 allow the control circuit 8 to communicate with the VICS center 14.

The communication unit 19 is communicably coupled to the cellular phone 17; this communication unit 19 allows the control circuit 8 to load information indicative of the operating state of the cellular phone 17, such as an off-hook state and on-hook state thereof. A handsfree kit 25 consists of, for example, a handsfree main unit, a speaker connected to the handsfree main unit, a microphone connected to the handsfree main unit, and cables connected between the handsfree main unit and the cellular phone 17.

The handsfree main unit is composed of an operating portion including keys and/or switches, and a control unit with a CPU and a memory in which a control program has been installed. Specifically, the control unit is programmed to control the whole of the handsfree unit 25. The handsfree main unit is also composed of an amplifying unit for controlling telephone call volume.

Specifically, the handsfree kit 25 enables the driver to talk on the cellular phone 17 without holding it while, for example, driving. The structure of the handsfree kit itself is commonly well known, and therefore, the detailed description of which is omitted.

The HDD 21 has stored therein a navigation program 21p required for the control circuit 8 to navigate the vehicle. The HDD 21 also has stored therein data required for the control circuit 8 when executing the navigation program 21p.

The control circuit 8 is designed as a common computer circuit. Specifically, the control circuit 8 is composed of a CPU 81, a ROM 82, a RAM 83, an input/output circuit (I/O) 84, and bus lines 85 such that the elements 81 to 84 are connected to each other through the bus lines 85.

As described above, the CPU 81 of the control circuit 8 loads the navigation program 21p and the data from the HDD 21 and runs the navigation program 21p using the data, thereby executing vehicle navigation process. The CPU 81 can read and write data on the HDD 21.

The control circuit 8 is also composed of an analog-to-digital (A/D) converting unit 86 including a common A/D converter. The A/D converting unit 86 is operative to:

receive the items of analog data input from the position detecting unit 1;

convert the items of analog data into items of digital data processable by the CPU 82; and

pass the items of digital data to the CPU 82.

Note that the map data can be stored in the HDD 21. A user (an occupant) can write assistant data for route guidance, entertainment data, and user's unique data into the HDD 21 based on operations of the operating switches 7 and the remote controller 12 and/or voice input from the microphone 31. Similarly, the data stored in the HDD 21 can be rewritten based on operations of the operating switches 7 and the remote controller 12 and/or voice input from the microphone 31.

The map data input unit 6 can read out the map data stored in the storage medium 20 and can update data stored in the HDD 21 to the map data. The CPU 81 can receive data from another one of control units installed in the vehicle through an in-vehicle LAN (local Area Network) 22 and can store the received data in the HDD 21.

The semiconductor memory device 9 consists of, for example, a rewritable semiconductor memory, such as a flash memory. The CPU 81 can store information and/or data, such as data associated with the current location of the vehicle, and/or data indicative of the set route, which is required for the navigation system 100 to operate, in the semiconductor memory device 9. The semiconductor memory device 9 can hold the stored data even thorough an accessory switch (ignition key) serving as a power supply switch for the navigation system 100 is in off state, in other words, the navigation system 100 is in off state.

The CPU 81 can store the information and/or data required for the navigation system 100 to operate in the HDD 21 or the RAM 83 in place of the semiconductor memory device 9.

In addition, the CPU 81 can divide the information and/or data required for the navigation system to operate between the semiconductor memory device 9 and the HDD 21. In this case, because the access rate to the semiconductor memory device 9 is faster than that to the HDD 21, the CPU 81 can store some items of the information and/or data, which are comparatively active, in the semiconductor memory device 9, and the remaining items thereof, which are comparatively inactive, in the HDD 21. Moreover, the CPU 81 can back up the contents of information and/or data stored in the semiconductor memory device 9 to the HDD 21.

The display device 10 consists of, for example, a common color liquid crystal display device, which is composed of, for example, a dot matrix LCD (Liquid crystal Display) and a driver for LCD display control. Specifically, the display device 10 according to the embodiment is designed as an active matrix display device such that each pixel (dot) of the dot matrix LCD is actively controlled by a switching element (diode or a transistor) by the driver. This allows the driver to turn on or off desired switching elements corresponding to targets of pixels (dots). The display device 10 is operative to execute display operations based on display instructions and screen image data sent from the control circuit 8.

For example, operations of the control circuit 8 allow the map data read out from the storage medium 20 to be displayed on the screen of the display device 10. In addition, operations of the control circuit 8 permit an icon indicative of the current position of the vehicle based on the items of data sensed by the position detecting unit 1 and additional markers indicative of, for example, the set route to a specified destination to be overlapped on the displayed map data. In addition, on the screen of the display device 10, menu window containing buttons that allow an occupant to set the route to the destination. The menu window also permits an occupant to switch the displayed image data, and/or the guidance while guiding the vehicle on the set route to another.

The speaker 15 is connected to the voice synthesizer 24 connected to the I/O 84. When the navigation program 21p causes the control circuit 8 to output digital sound data corresponding to voice guidance messages stored in the semiconductor memory device 9 or the HDD 21 to the voice synthesizer 24, the voice synthesizer 24 is operative to convert the digital sound data into analog sound data. The speaker 15 is operative to change the analog sound corresponding to digital sound data to sound waves and to output them as voice guidance messages.

Note that various methods of voice synthesis can be used by the voice synthesizer 24 as follows, For example, a recording and editing method codes speech waveform, to recode the codes, and pieces some of the codes to create analog sound data when needed. A parameter editing method analyzes speech waveform so as to convert it into parameters, recodes them, and pieces some of the recorded parameters to create analog sound data. A rule synthesizing method creates analog sound data from character string and/or phonemic symbol string based on phonetic and linguistic rule. The voice synthesis functions of the voice synthesizer 24 can be installed in the control circuit 8 as its functions based on voice synthesis programs.

The control circuit 8 is connected to vehicle speed sensors 23 and a fuel level sensor 26.

The vehicle speed sensors 23 include rotation detecting devices, such as common rotary encoders, disposed close to shafts, the ends of each shaft of which wheels are attached. The rotation detecting devices work to detect the revolutions of the wheels and to send the detected rotation to the control circuit 8 as pulse signals. The control circuit 8 is operative to convert the revolutions of the wheels into a vehicle speed, to estimate the arrival time based on the current vehicle position and the current vehicle speed, and to calculate an average speed every section of each road. The control circuit 8 can receive the vehicle speed from other in-vehicle units through the in-vehicle LAN 22.

In the structure of the navigation system 100 set forth above, while the navigation program 21p is running on the control circuit 8, when the driver selects route guide process on the menu window displayed on the screen of the display device 10 based on operations of the operating switches 7 or the remote controller 12, or voice input to the microphone 31, the CPU 81 of the control circuit 8 for example carries out the following operations.

Specifically, when the driver inputs the destination based on the map data displayed on the screen of the display device 10, the CPU 81 obtains the current vehicle location based on the items of digital data corresponding to the items of analog data sent from the position detecting unit 1. Subsequently, the CPU 81 automatically calculates the best route from the current vehicle position to the destination using, for example, Dijkstra method (algorithm), and overlaps the calculated best route on the displayed map data, thereby giving the best route to the driver. In addition, the CPU 81 uses at least one of the display device 10 and the set of the voice synthesizer 24 and the speaker 15 to give guidance of the driving operation to the driver and messages depending on the operating condition (vehicle condition) thereto.

The Dijkstra method calculates a route evaluated value, that is, route calculation cost from the current vehicle position to each node based on the link information, node information, and inter-link connection information. After completion of all route evaluated values up to the destination, the Dijkstra method connects links and nodes such that the total evaluated value of the set of connected nodes and links connecting between the current vehicle position and the destination is minimum, thereby determining the set of connected node and links having the minimum of the total evaluated value as the best route from the current vehicle position to the destination.

In the Dijkstra method, the route evaluated values are calculated based on the length, the type, the width, the number of traffic lanes, the presence or absence of signals and right and left turns of each road (each link), and the like. For example, the wider the width of a road is, the lower the route evaluated value using the road is, and the larger the number of traffic lanes of a road is, the lower the route evaluated value using the road is.

Calculation of the route evaluated value (route calculation cost) at each link can be performed using the following equation:
Route calculation cost=A×B×C×D
Where A shows length of each link (road), B shows road width coefficient representing a coefficient individually set depending on each width of each road (link), C shows rode type coefficient representing a coefficient individually set depending on each type of each road (link), such as toll road, and D shows degree of traffic congestion representing a coefficient individually set depending on the degree of traffic congestion of each road (link).

The fuel level sensor 26 is configured to measure change of the level of a float floating on the fuel surface of the fuel in a fuel tank, which corresponds to the level of fuel therein, as change of resistance of a potentiometer attached to the float. The potentiometer provides an analog voltage proportional to the resistance corresponding to the level of the fuel in the fuel tank to the control circuit 8. The A/D converting unit 86 converts the analog voltage into a digital value to send it to the CPU 81. The CPU 81 calculates the remaining amount of the fuel in the fuel tank based on the digital value. The CPU 81 can take, through the in-vehicle LAN 22, data representing the remaining amount of the fuel in the fuel tank from another one of the external in-vehicle units. Another one of the external in-vehicle units can obtain the data representing the remaining amount of the fuel in the fuel tank, such as an instrumental panel ECU for controlling display of an instrumental panel, such as fuel level display thereof.

As set forth above, the control circuit 8 of the navigation system 100 is configured to automatically calculate the best route from the current vehicle position to the destination and to overlap the calculated best route on the displayed map data when the driver inputs the destination using any one of the operating switches 7, the remote controller 12, and the set of the microphone 31 and the voice recognition unit 30.

Simultaneously, the control circuit 8 sets junctions including intersections on the best route as guidance object points each with a predetermined geographical position as an example of guidance objects. The control circuit 8 determines at least one guidance providing point for each guidance object point when the vehicle reaches a predetermined distance before each guidance object point. The at least one guidance providing point is set as a point at which the control circuit 8 should give a voice guidance message associated with a corresponding guidance object point to the driver. Guidance providing points can be set to each guidance object point, such as 700 m, 300 m, and 100 m before each guidance object point.

Moreover, the control circuit 8 determines a guidance providing range for each guidance object point. The guidance providing range is set as a range in which the control circuit 8 should give a voice guidance message associated with a corresponding guidance object point to the driver, and within which the driver can respond to the voice guidance message. For example, a point directly before a guidance object point, or a point immediately after a guidance object point at which the driver cannot respond to the voice guidance message is out of the guidance providing range for the guidance object point. The user can set the guidance object points, the guidance providing points, and the guidance providing ranges using at least one of the operating switches 7, remote controller 12, and the set of the microphone 31 and the voice recognition unit 30.

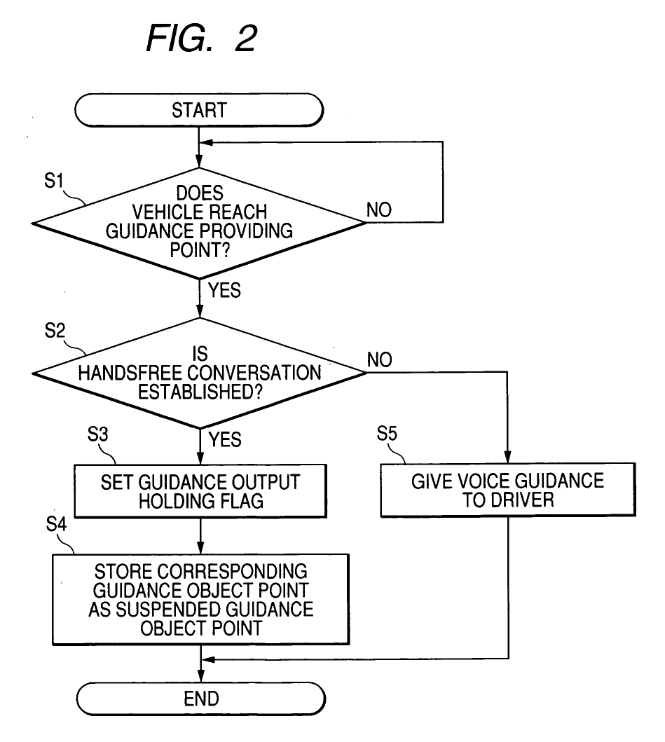

Next, operations of the control circuit 8 during handsfree conversation will be described hereinafter using FIG. 2. The operations are for example repeatedly carried out by the control circuit 8 in accordance with part of the navigation program 21p with other operations based on the program 21p.

First, the control circuit 8 compares the calculated current vehicle position based on the items of analog data sent from the position detecting unit 1 with each of the guidance providing points to determine whether the vehicle reaches one of the guidance providing points in step S1 of FIG. 2.

If it is determined that the vehicle reaches one of the guidance providing points (the determination in step S1 is YES), the control circuit 8 obtains the operating state of the cellular phone 17 through the communication unit 19 to determine whether handsfree conversation is established based on the operating state of the cellular phone 17 in step S2.

Because the communication unit 19 is communicable with the cellular phone 17 so that the communication unit 19 is accessible to the cellular phone 17 to detect whether the cellular phone 17 is in off-hook state and whether the handsfree kit 25 is connected to the cellular phone 17, the control circuit 8 can obtain information of whether the cellular phone 17 is in off-hook state and/or that of whether the handsfree kit 25 is connected to the cellular phone 17 from the communication unit 19. This allows the control circuit 8 to determine whether handsfree conversation is established.

If it is determined that the handsfree conversation is not established (the determination in step S2 is NO), the control circuit 8 gives a voice guidance message corresponding to the one of the guidance providing points through the voice synthesizer 24 and the speaker 10 to the driver in step S5.

Otherwise, if the handsfree conversation is established (the determination in step S2 is YES), the control circuit 8 sets a guidance output holding flag for one of the guidance object points corresponding to the one of the guidance providing points in a first predetermined area reserved in the RAM 82 or the semiconductor memory device 9 in step S3. Next, the control circuit 8 stores, in a second predetermined area of the RAM 82 or the semiconductor memory device 9, information representing that one of the guidance object points corresponding to the one of the guidance providing points is a suspended guidance object point in step S4,

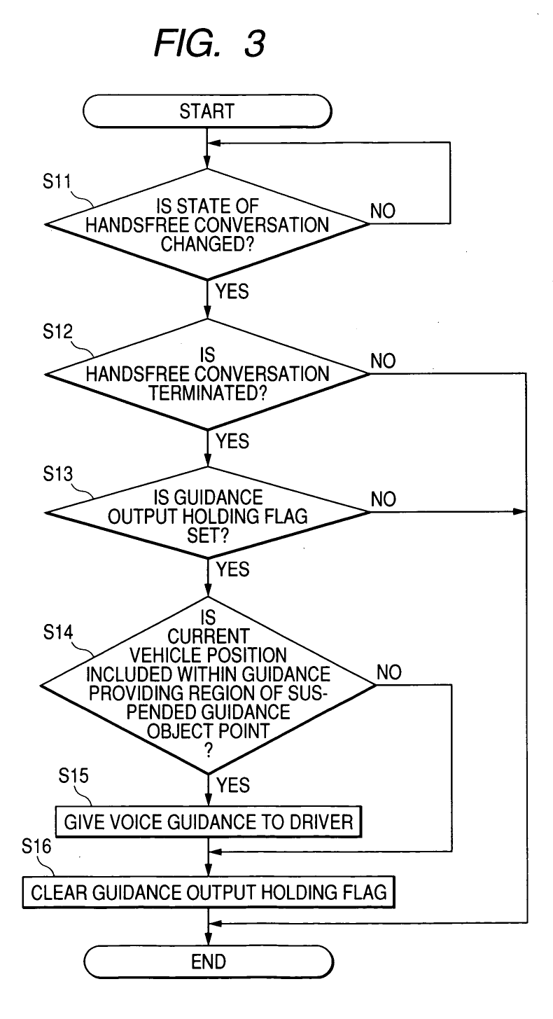

Next, operations of the control circuit 8 when the handsfree conversation is terminated will be described hereinafter using FIG. 3. The operations are for example repeatedly carried out by the control circuit 8 in accordance with part of the navigation program 21p with other operations based on the program 21p.

The control circuit 8 monitors whether the state of handsfree conversation is changed based on the operating state of the cellular phone 17 in step S11. If it is determined that the state of handsfree conversation is changed (the determination in step S11 is YES), the control circuit 8 determines whether the handsfree conversation is terminated based on the operating state of the cellular phone 17 in step S12.

If it is determined that the handsfree conversation is terminated because the cellular phone 17 is in on-hook state (the determination in step S12 is YES), the control circuit 8 shifts to step S13. In step S13, the control circuit 8 refers to the first predetermined area of the RAM 82 or the semiconductor memory device 9 and to check whether the guidance output holding flag is set in the first predetermined area in step S13.

If it is determined that the guidance output holding flag is set in the first predetermined area (the determination in step S13 is YES), the control circuit 8 shifts to step S14. In step S14, the control circuit 8 refers to the second predetermined area of the RAM 82 or the semiconductor memory device 9 to determine whether the current vehicle position is included within the guidance providing range corresponding to the suspended guidance object point stored in the second predetermined area.

If it is determined that the current vehicle position is included within the guidance providing range corresponding to the suspended guidance object point (the determination in step S14 is YES), the control circuit 8 shifts to step S15. In step S15, the control circuit 8 gives a voice guidance message corresponding to, for example, a guidance providing point belonging to or close to the guidance providing range through the voice synthesizer 24 and the speaker 10 to the driver in step S15, proceeding to step S16.

Otherwise, if the current vehicle position is not included within the guidance providing range corresponding to the suspended guidance object point (the determination in step S14 is NO), the control circuit 8 shifts to step S16 without performing the operation in step S15.

In step S16, the control circuit 8 clears the guidance output holding flag set in the first predetermined area, and deletes the suspended guidance object point stored in the second predetermined area.

In the embodiment, the guidance providing range can be set within 50 m of a corresponding guidance object point. Moreover, guidance providing ranges can be set to the guidance object points depending on the types thereof, respectively.

For example, when the vehicle reaches 100 m before the destination, if the handsfree conversation is established, a voice guidance message of “Here is the periphery of the destination, so voice guidance is terminated” cannot be given to the driver (see steps S3 and S4).

When the handsfree conversation is terminated immediately before the destination, the voice guidance message of “Here is the periphery of the destination, so voice guidance is terminated” can be given to the driver (see steps S11 to S15).

In contrast, if the vehicle has already reached the destination when the handsfree conversation is terminated, the voice guidance message of “Here is the periphery of the destination, so the guidance is terminated” can be prevented from being given to the driver (see the negative determination in step S14).

Moreover, when timing of giving a voice guidance message of traffic congestion ahead on the set route occurs during handsfree conversation based on, for example, the latest traffic information sent from the VICS center 14, it is possible to give the voice guidance message of traffic congestion ahead on the best route after on-hook of the cellular phone 17 (completion of the handsfree conversation). This allows the driver to change the set route based on the given voice guidance message of traffic congestion ahead thereon.

As described above, in the embodiment, when the vehicle reaches one of the guidance providing points, if the handsfree conversation is established, it is possible to set a guidance output holding flag for one of the guidance object points corresponding to the one of the guidance providing points without giving the driver a voice guidance message corresponding to the one of the guidance providing points. In other words, it is possible to hold output of the voice guidance message corresponding to the one of the guidance providing points during handsfree conversation. This can prevent the handsfree conversation from being interrupted by the voice guidance.

Specifically, in the embodiment, when determining that the handsfree conversation is terminated based on detection of the cellular phone being in on-hook state, it is possible to easily give the held voice guidance message and/or a voice guidance message to the driver after completion of the handsfree conversation.

That is, detection of the cellular phone being in on-hook state can clearly discriminate completion of the handsfree conversation from interruption of conversation between occupants without analyzing the details of the conversations. This allows output of the held voice guidance message and/or a voice guidance message to the driver after completion of the handsfree conversation without increasing the cost of the system 100.

Moreover, in the embodiment, immediately after completion of the handsfree conversation, it is possible to determine whether the current vehicle position is included within the guidance providing range corresponding to the suspended guidance object point. When the current vehicle position is not included within the guidance providing range corresponding to the held guidance object point, it is possible to therefore prevent a untimely voce guidance message associated with the held guidance object point from being given to the driver. This can avoid the driver from erroneously changing the set route to the destination based on the untimely voice guidance, and from being annoyed thereby.

In the embodiment, guidance object points on the set route, such as junctions, at which the driver require guidance to drive the vehicle along the set route are set as the guidance objects, but the present invention is not limited to the structure. Specifically, predetermined elements independent of the set route can be set as the guidance objects. For example, predetermined points on the map data, predetermined reminder points and/or facilities, such as border points between prefectures, points of curves, and crossings can be set as the guidance objects. Moreover, traffic congestion points based on the latest traffic information from the VICS center 14, and specific road condition points, such as points of roads under construction, can be set as the guidance objects. The guidance providing range can be determined for each of the guidance objects.

When the vehicle reaches one of the guidance providing points corresponding to one of the guidance objects during handsfree conversation, it is possible to give a voice guidance message corresponding to the one of the guidance providing points or another guidance providing point after on-hook of the cellular phone 17 if the current vehicle position is included within the guidance providing range corresponding to the one of the guidance objects at the on-hook of the cellular phone 17.

In the embodiment, fuel level information indicative of the remaining amount of the fuel in the fuel tank based on the measured voltage of the fuel level sensor 26, vehicle information such as fault information of the vehicle, and weather information, such as rainfall information and snowfall information, can be set as the guidance objects. Moreover, event information, which is indicative of the occurrence of an event, such as the time tone and an alert and is given to the driver as voice, can be set as the guidance object.

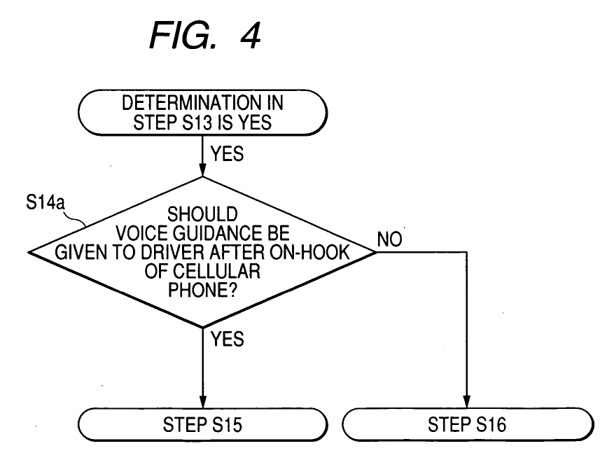

In this modification, in step S14a of FIG. 4 for example, the control circuit 8 determines whether a voice guidance message associated with one of the guidance objects should be given to the driver after on-hook of the cellular phone 17. If it is determined that the voice guidance message associated with the one of the guidance objects should be given to the driver after on-hook of the cellular phone 17 (the determination in step. S14a is YES), the control circuit 8 gives the voice guidance message associated with the one of the guidance objects through the voice synthesizer 24 and the speaker 10 to the driver in step S15.

For example, if the one of the guidance objects is the fuel level information, and the fuel level information represents that the remaining amount of the fuel in the fuel tank is below a predetermined threshold level, the determination in step S14a is affirmative. The control circuit 8 therefore gives a voice guidance message associated with the fuel level information through the voice synthesizer 24 and the speaker 10 to the driver in step S15.

Similarly, if the one of the guidance objects is the vehicle information, and the vehicle information represents that a serious failure requiring immediate stop of the vehicle and immediate remedy occurs, the determination in step S14a is affirmative. The control circuit 8 therefore gives a voice guidance message associated with the vehicle information through the voice synthesizer 24 and the speaker 10 to the driver in step S15.

Moreover, if the one of the guidance objects is the weather information, and the weather information represents that the weather is expected to immediately worsen, the determination in step S14a is affirmative. The control circuit 8 therefore gives a voice guidance message associated with the weather information through the voice synthesizer 24 and the speaker 10 to the driver in step S15.

Furthermore, if the one of the guidance objects is the event information, and the event information represents that an alert is announced on the set route, the determination in step S14a is affirmative. The control circuit 8 therefore gives a voice guidance message associated with the event information through the voice synthesizer 24 and the speaker 10 to the driver in step S15.

Whether a failure occurs in the vehicle can be determined using vehicle condition parameters of information including the states of: engine speed, the brake, the transmission, the inflation pressure of each tire, the engine oil, the water temperature of the cooling water, the battery voltage, and the like. The vehicle condition parameters of information can be obtained by the control circuit 8 from ECUs (Electronic Control Units) installed in the vehicle through the in-vehicle LAN 22.

When the current vehicle position is located within one of the guidance providing ranges during handsfree conversation, a voice guidance message indicative of “You cannot obtain voice guidance due to handsfree conversation” can be displayed on the screen of the display device 10.

In the embodiment, the control circuit 8 sets a guidance output holding flag for any one of the guidance objects in step S3, but the present invention is not limited to the structure.

Specifically, in a first modification, the guidance objects can be separated into at least the first and second groups. The first group includes some of the guidance objects directly linked to the set route, and the second group includes the remaining guidance objects that are not directly linked to the set route, such as the vehicle information, the weather information, and the like. An occupant, such as the driver, can set any one of the first and second groups as the target for holds during handsfree conversation using any one of the operating switches 7, the remote controller 12, and the set of the microphone 31 and the voice recognition unit 30.

Specifically, in the first modification, when, for example, the first group is set as the target for holds during handsfree conversation by an occupant, such as the driver. The information indicative of whether any one of the first and second groups is set as the target for holds during handsfree conversation is stored by the control circuit 8 in the semiconductor memory device 9 as hold-target set information.

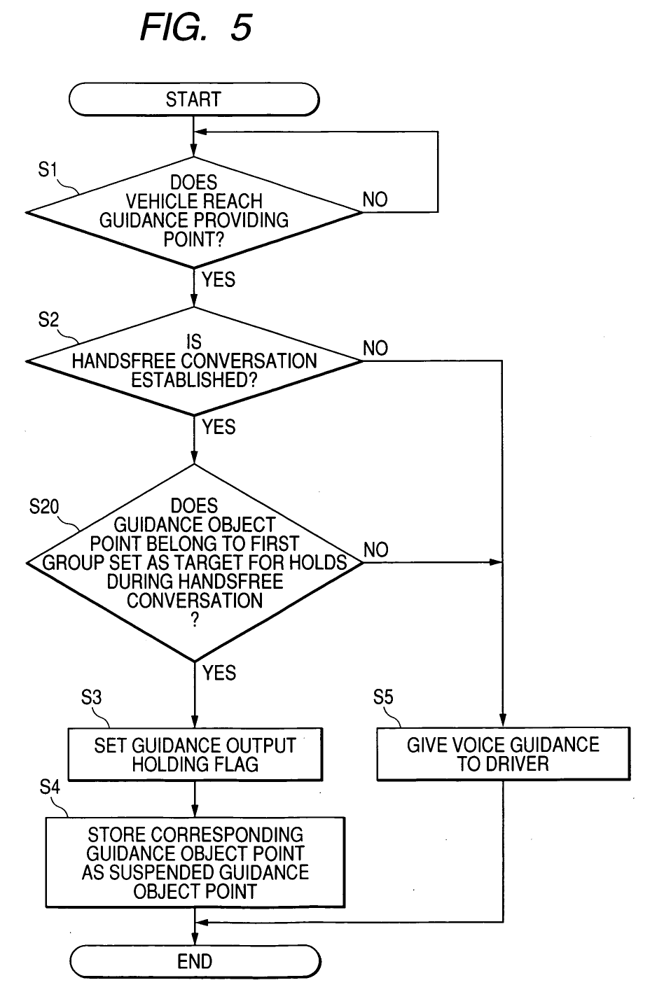

As illustrated in FIG. 5, after the affirmative determination in step S2, the control circuit 8 refers to the hold-target set information stored in the semiconductor memory device 9 and determines whether the one of the guidance object points corresponding to the one of the guidance providing points belongs to the first group based on the referred result in step S20.

If it is determined that the one of the guidance object points belongs to the first group (the determination in step S20 is YES), the control circuit 8 determines that the one of the guidance object points is the target for holds during handsfree conversation, shifting to step S3. This results in that output of a voice guidance message corresponding to the one of the guidance object points is held.

Otherwise, if the one of the guidance object points does not belong to the first group (the determination in step S20 is NO), the control circuit 8 determines that the one of the guidance object points is not the target for holds during handsfree conversation, shifting to step S5. This results in that the voice guidance message corresponding to the one of the guidance object points is given to the driver.

As described above, in the first modification, it is possible for an occupant, such as the driver, to selectively set at least one of the guidance objects as the target for holds during handsfree conversation based on, for example, degree of relevance of each guidance object to the set route. This allows the driver to set at least one of the guidance objects, which the driver thinks is unnecessary, as the target for holds during handsfree conversation, preventing the driver from being annoyed by the unnecessary voice guidance messages corresponding to the set at least one guidance object.

Furthermore, in a second modification, a number of levels of weight can be assigned to the voice guidance messages according to the contents and/or types thereof, Some of the voice guidance messages to which some levels of weight higher than a predetermined level of weight are assigned can be only set as the target for holds during handsfree conversation.

For example, the level of weight of 4 is assigned to voice guidance messages corresponding to the guidance objects directly linked to the set route, and the level of weight of 5 is assigned to voice guidance messages corresponding to the some items of the vehicle information, which may interfere with the drive. The level of weight of 2 is assigned to voice guidance messages corresponding to the guidance objects independent of the set route, such as predetermined points on the map data, predetermined reminder points, and/or facilities, such as border points between prefectures, points of curves, and crossings. The level of weight of 3 is set to a threshold level.

An occupant, such as the driver, can assign the levels of weight to each of the voice guidance messages, and set the threshold level using any one of the operating switches 7, the remote controller 12, and the set of the microphone 31 and the voice recognition unit 30. The information indicative of the set threshold level and of each level of weight to each of the voice guidance messages is stored by the control circuit 8 in the semiconductor memory device 9 as weight information.

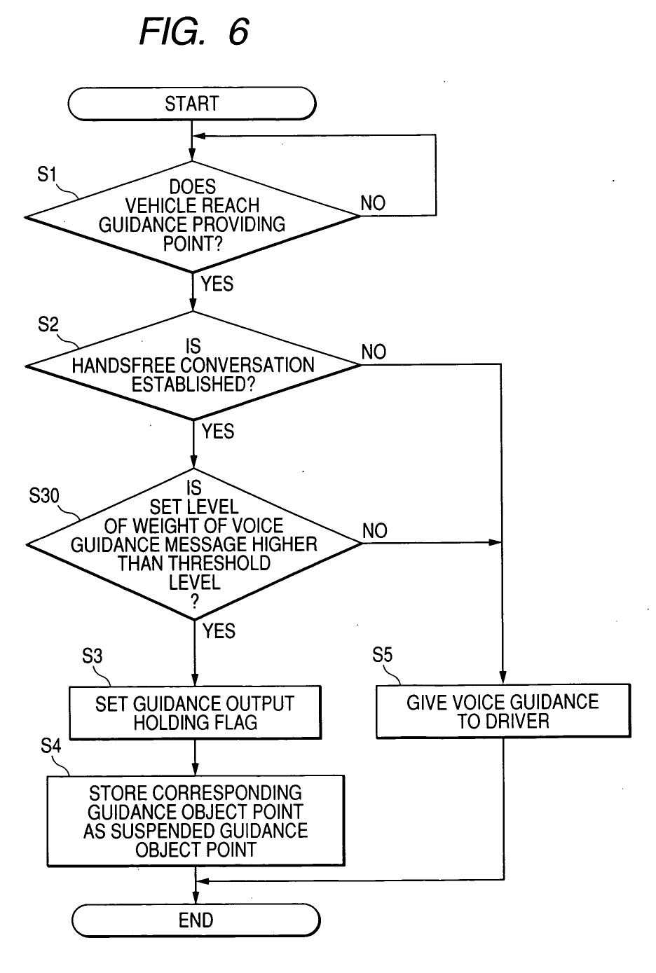

As illustrated in FIG. 6, after the affirmative determination in step S2, the control circuit 8 refers to the weight information stored in the semiconductor memory device 9 and determines whether the voice guidance message associated with the one of the guidance object points corresponding to the one of the guidance providing points is higher than the threshold level based on the referred result in step S30.

If it is determined that the set level of weight of the voice guidance message associated with the one of the guidance object points corresponding to the one of the guidance providing points is higher than the threshold level (the determination in step S30 is YES), the control circuit 8 determines that the one of the guidance object points is the target for holds during handsfree conversation, shifting to step S3. This results in that output of the voice guidance message corresponding to the one of the guidance object points is held.

Otherwise, if the set level of weight of the voice guidance message associated with the one of the guidance object points is equal to or lower than the threshold level (the determination in step S30 is NO), the control circuit 8 determines that the one of the guidance object points is not the target for holds during handsfree conversation, shifting to step S5. This results in that the voice guidance message corresponding to the one of the guidance object points is given to the driver.

As described above, in the second modification, it is possible for an occupant, such as the driver, to selectively set at least one of the guidance objects as the target for holds during handsfree conversation based on, for example, the levels of weight of corresponding voice guidance messages. This allows the driver to set at least one of the guidance objects, which the driver thinks is unnecessary, as the target for holds during handsfree conversation, preventing the driver from being annoyed by the unnecessary voice guidance messages corresponding to the set at least one guidance object.

The occupant's setting associated with the functions of the control circuit 8 can be carried out based on the menu window displayed on the screen of the display device 10 using the operating switches 7, the remote controller 12, or the set of the microphone 31 and the voice recognition unit 30. For example, operations of the operating switches 7 or the remote controller 12, or voice input to the microphone 31 allows function setting menu window to be displayed on the screen of the display device 10. The function menu window permits an occupant, such as the driver, to input various instructions to the control circuit 8. On the menu window, the driver inputs an instruction for displaying a setting window permitting the driver to set various items of voice guidance during handsfree conversation. The instruction allows the control circuit 8 to display the setting window on the screen of the display device 10.

The driver selects and/or sets the items of voice guidance on the setting window so that the selected and set items of data are stored in a predetermined area of the semiconductor memory device 9 or the HDD 21.

In the embodiment, as an example of sound information output systems, the vehicle navigation system is described, but the present invention is not limited to the structure. Specifically, the present invention can be applied to a sound information output system configured to simply output sound information in a vehicle.

While there has been described what is at present considered to be the embodiments and modifications of the present invention, it will be understood that various modifications which are not described yet may be made therein, and it is intended to cover in the appended claims all such modifications as fall within the true spirit and scope of the invention.

What is claimed is:

1. A sound information output system installed in a vehicle and configured to output first sound information, the system comprising:
a first determining unit communicable with a handsfree cellular phone unit that allows handsfree conversation and configured to determine whether the handsfree cellular phone unit is in off-hook state or in on-hook state; and
a holding unit configured to hold output of the first sound information when it is determined that the handsfree cellular phone unit is in off-hook state.

2. A sound information output system according to claim 1, further comprising
a first output unit configured to output at least one of the held first sound information and second sound information when it is determined that the handsfree cellular phone unit is in on-hook state.

3. A sound information output system according to claim 1, wherein the first sound information includes a plurality of sound messages, further comprising:
a second determining unit configured to determine whether each of the plurality of sound messages is required to be output.

4. A sound information output system according to claim 3, wherein each of the sound messages is set to a predetermined geographical position, and the second determining unit further comprises:
a range setting unit configured to set a range for the predetermined position of each of the sound messages;
a current vehicle position detecting unit configured to detect a geographical current position of the vehicle when it is determined that the handsfree cellular phone unit is in on-hook state;
a third determining unit configured to determine whether the detected geographical current position of the vehicle is within the range of each of the sound messages; and
a second output unit configured to output one of the sound messages when it is determined that the detected geographical current position of the vehicle is within the range of the one of the sound messages.

5. A sound information output system according to claim 3, wherein the second determining unit further comprises:
a requirement setting unit configured to set a requirement that at least one of the sound messages meets;
a fourth determining unit configured to determine that at least one of the plurality of sound messages is required to be output when the at least one of the sound messages meets the requirement; and
a third output unit configured to output the at least one of the sound messages.

6. A sound information output system according to claim 5, wherein the sound messages are separated into a first group and a second group, the first group being directly linked to guidance for a route of the vehicle, and the second group being directly independent of the guidance for the route, the requirement represents one of the first and second groups, and the fourth determining unit is configured to determine that at least one of the plurality of sound messages is required to be output when the at least one of the plurality of sound messages belongs to the one of the first and second groups.

7. A sound information output system according to claim 5, wherein the sound messages include types and contents such that levels of weight are assigned to the sound messages according to at least one of the contents and types thereof, respectively, the requirement setting unit is configured to set a predetermined threshold level of weight as the requirement, and the fourth determining unit is configured to determine that at least one of the plurality of sound messages is required to be output when the level of weight of the at least one of the sound messages is higher than the threshold level.
